(19) United States
(12) Patent Application Publication
(10) Pub. No.: US 2012/0061150 A1
(43) Pub. Date: Mar. 15, 2012

(54) Rotary Carousel Scale

(76) Inventors: Alexandre Coulombe, Saint-Germain de Grantham (CA); Noramand Roy, St-Hugues (CA); Marc-André Patry, Drummondville (CA); Vincent Morin, Drummondville (CA); Jérémie Aubin-Marchand, St-Hugues (CA); Erick Bienvenue, Sherbrooke (CA)

(21) Appl. No.: 12/878,603

(22) Filed: Sep. 9, 2010

(51) Int. Cl. G01G 15/00

(52) U.S. Cl. 177/54

(57) ABSTRACT

The present invention provides a high-accuracy rotary carousel scale with a rotary platter. The rotary carousel scale utilizes a plurality of load cells of either planar-beam or single-point type, fitted with a stabilizing structure and wheels to support the rotary platter. The stabilizing structure prevents side forces and moment forces being applied to the load cells, allowing their full accuracy to be maintained, as well as protecting them from damage. The rotary platter provides support for, and weighs, bags of purchased products in the self-checkout and related industries and is rotated to access individual bags during filling. The rotary carousel scale can incorporate devices to prevent damage to the load cells during an overload. Alternatively, the rotary carousel scale can rely for this on overload prevention built-into the load cell mount.

### CROSS-REFERENCE TO RELATED APPLICATIONS

There are no cross-related applications.

### FIELD OF THE INVENTION

The present invention generally relates to scales and weighing apparatus employing load cells and having means to prevent damage of the load cell due to an overload, and more particularly to rotary carousel scales.

### BACKGROUND OF THE INVENTION

Many checkout stations in retail establishments embody a rotary platform on which is mounted a series of bag racks. Each bag rack contains a stack of plastic bags, the front one of which can be opened in order to pack goods after scanning them prior to making payment. Since the bag racks are arranged in a circular fashion, successive bags can be brought to the front for packing by rotating the platform.

On self-checkout versions of these stations, in which customers do their own scanning and packing, a means is necessary for checking that the items placed in the bags are the same as scanned, to detect for possible fraud. Weight can be used for this check and when this is required, a rotating platform can be constructed so as to weigh the bags and contents. In common with static types of scale used for this purpose, the scale requires a high resolution and fast response. When a round, rotary platter is required, the easiest method of support is a centrally mounted “single-point” load cell designed to support such a rotary platter when fitted with a bottom and top frame.

Rotary carousel scales can be constructed using a single, centrally mounted load cell with bottom and top frames. The bottom frame fits inside the scale housing and supports the scale while the top frame is fitted with a centrally mounted shaft which holds the rotary platter in position; wheels mounted on the extremities support the rotary platter and allow it to rotate freely. This arrangement, whilst providing adequate strength and performance, is expensive to construct and awkward to transport.

A much lower cost solution is to mount four load cells at the platform support points and tie their upper load application points together with a sub-frame which in turn supports four or more wheels. A shaft is mounted at the center of this sub frame to hold the platform in position. Overload protection for the load cells can be incorporated internal to the load cell mounts or be external, as part of the frame. The assembly has a much lower overall cost, is highly accurate and can be shipped as a complete assembly or as a kit, saving space and shipping cost.

### SUMMARY OF THE INVENTION

The aforesaid and other objectives of the present invention are realized by generally providing a rotary carousel scale comprising a rotary platter mounted on a shaft, the shaft being located at the center of the rotary platter, the rotary platter being free to rotate along the shaft; at least three load cells comprising loading points; a plurality of resilient mounts, the resilient mounts being connected to the loading points of the load cells; a frame disposed on the resilient mounts; a plurality of wheels, the wheels being disposed on the frame, the rotary platter being disposed on the wheels, and the rotary platter rotating on the wheels.

The invention described herein provides a rigid frame attached to a plurality high-accuracy load cells.

In a preferred embodiment, the rotary platter is mounted on a rigid frame attached to four high-accuracy load cells. The load cells can be mounted on a frame which is part of the structure of the checkout counter, whilst the rotary platter provides the base on which the bag racks are attached. Since the load cells are adjusted to all have the same output, the scale weighs objects placed on it with high accuracy, regardless of their position on the platform.

In a still preferred embodiment, the frame is rigidly attached to the resilient mounts. The rotary carousel scale may further comprise an overload protection device comprising a body and a stop portion, the stop portion being adapted to stop a downward movement of the frame. In a still preferred embodiment, each of the load cells is installed underneath one of the wheels.

One of the objectives in this particular design is cost. The use of very low cost load cell assemblies with a light frame to support the wheels and platform result in a cost-effective solution that also eases shipment and service.

The rotary carousel scale of the present invention supports a rotary platter in such a way that it is free to rotate while weighing items placed anywhere on the rotary platter with a high degree of accuracy.

The rotary carousel scale of the present invention allows several load cells to be coupled together at their loading points in such a way that their individual and joint accuracy is not impeded.

The rotary carousel scale of the present invention provides a stable mounting surface for the wheels that support the rotary platter, which sufficient strength to support the full gross weight of the rotary platter and load.

The rotary carousel scale of the present invention either allows the load cells' built-in overload protection to function or provides external overload protection for the load cells.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a perspective view of a carousel-type self serve checkout station.

FIG. 2 is a perspective view of the scale assembly.

FIG. 3 is a side view showing the components of the vertical overload protection mechanism when in the non-overloaded state.

FIG. 4 is a side view of another embodiment of the scale assembly.

### DETAILED DESCRIPTION OF THE PREFERRED EMBODIMENT

A novel rotary carousel scale will be described hereinafter. Although the invention is described in terms of specific illustrative embodiment(s), it is to be understood that the embodiment(s) described herein are by way of example only and that the scope of the invention is not intended to be limited thereby.

It is to be noted that the rotary carousel scale described in the present application is not limited to supermarket application. Indeed, the invention described can be used with almost any application involving a rotary carousel scale.

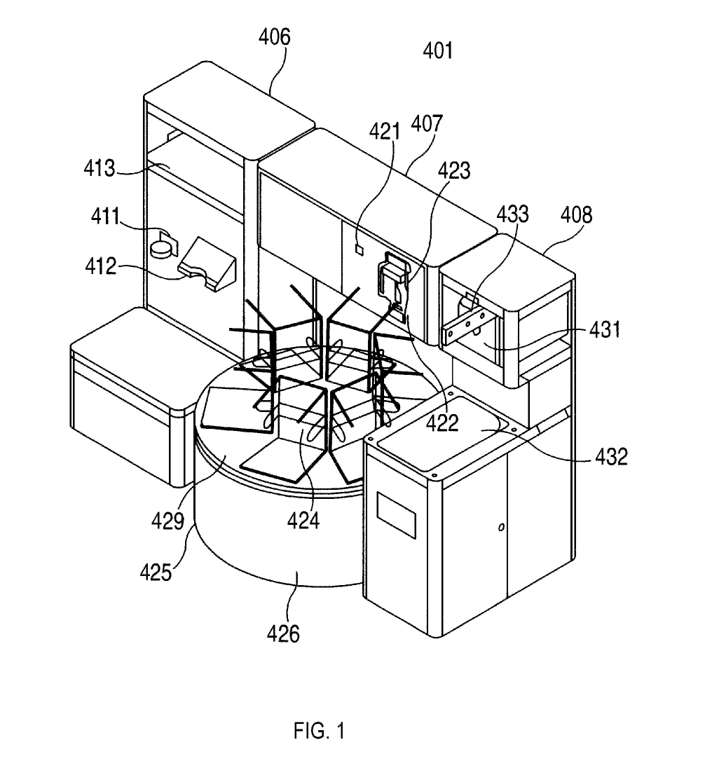

FIG. 1 shows an embodiment of a carousel-type self-server checkout station 401. Self-serve checkout station 401 includes modules 406, 407 and 408. Module 408 includes touchscreen display 431, scanner-scale 432 and optionally a video camera 433. A microprocessor-based computer, which controls operations of the apparatus, is in a compartment of module 408 under the scanner-scale 432. A speaker and a microphone also may be provided. Scanner 432 may be supplemented, or perhaps replaced, by other devices, such as keypads, optical character scanners and/or voice input devices, for entering the product code of an item to be purchased. Module 407 comprises coin acceptor 421, bill acceptor 422, reader 423 for credit cards, charge cards and/or store cards, bagging rack 424 and carousel assembly 425. The rack 424 shown is configured for six bags. This configuration, however, is not a limitation of the present invention. A rack accommodating four, five, or more than six bags alternatively may be used. The capacity is only limited by the strength of the rack assembly and the size of the carousel. The bagging rack 424 and rotary platter 429 are free to rotate so that the customer can select an appropriate bag into which a scanned item can be placed. The apparatus is able to maintain a stable weight and is unaffected by lateral movement and rotation. The modular configuration of station 401 permits modules 406 through 408 to be assembled from left to right or from right to left. Module 407 preferably is in the center to make packing more efficient. Alternatively, module 408 with scanner 432 may be in the center. The bagging rack shown in FIG. 1 is one of many possible designs. The rack may take on any of the many designs known in the art that allow bags to remain in an open configuration so that items can be packed efficiently in the bags.

Self-serve checkout station preferably includes a computer which may be configured similar to known microprocessor-based computers and has a CPU, a plurality of storage devices and an I/O interface. The storage devices may include program memory, RAM, non-volatile memory (such as ROM, EEPPROM, etc.), and any or a combination of the mass storage devices known conventionally in the art, such as floppy disk, optical disk, hard disk and/or tape cartridge drives, plus appropriate device drivers. A product lookup database may be stored in the storage devices. The CPU communicates via the I/O interface with the load cells (not shown in FIG. 1) and scanner-scale 432, as well as with touchscreen display 431, other product code entry devices, video camera 433, coin acceptor 421, bill acceptor 422, card reader 423, coin dispenser 411, bill dispenser 412 and receipt printer 413. Operation of touchscreen display 431, scanner 432 and other product code entry devices, video camera 433, coin acceptor 421, bill acceptor 422, card reader 423, bagging rack 424, coin dispenser 411 and receipt printer 413 are conventional and known in the art,

The rotary platter 101 shown in FIG. 1 to FIG. 4 is circular, however, it may have another shape, such as pentagonal, a hexagonal, octagonal, or the like. The main requirement is that the carousel assembly can accommodate multiple bags (three or more) in a large order purchase. It is also desirable that the carousel is rotatable such that the shopper can easily select an appropriate one of the multiple bags into which a scanned item can be placed.

According to the present invention, the rotary carousel scale comprises three, four or more load cells 101 that support a frame or plate 102 which in turn supports a plurality of wheels 103, mounted in suitable brackets. The wheels 103 are in contact with the bottom surface 120 of the rotary platter 105. In the embodiment shown in FIG. 1 to FIG. 4, planar beam load cells are shown, although several different forms of load cell could equally be chosen. A central shaft 104 is connected to the center of the circular platform or rotary platter 105 in such a way that the rotary platter sits on the wheels 103 and is free to rotate along the central shaft 104. The load cells 101 are connected to a suitable weight indicator, computer or similar device such that objects placed on the rotary platter 105 can be weighed with high accuracy, regardless of their location on the rotary platter 105. Resilient mounts 106 are fitted between the loading points (location where the load is transmitted to the load cell) of the load cells 101 and the frame 102 to eliminate the interaction that can occur between load cells 101 if the frame 102 and the load cells 101 are rigidly connected, whilst providing extra protection against high-frequency shock loads. In a preferred embodiment, an overload protection device 107 is provided. The overload protection device 107 comprises a body 127 are a stop portion 125. The stop portion 125 is the portion adapted to contact the frame 102. The overload protection device 107 is preferably rigid. The overload protection device 107 is adjusted to provide a gap 108 between the stop portion 125 and the bottom surface 109 of the frame 102. The resilience of the resilient mount 106 allows the frame 102 to descend as load applied on the rotary platter 105 increases, until the frame 102 contacts the stop portion 125 and prevents further motion. This protects the load cell 101 against vertical overload. Although the frame 102 is illustrated as being rigidly attached to the resilient mounts 106, it could equally be placed loosely on resilient mounts of various forms which are placed on top of the load cells 101.

The use of resilient mounts eliminates side loading and moment forces from affecting the load cells.

It is to be noted that the wheels may be mounted on the frame directly over or close to the load cell support points or not. However, when each of the load cells are mounted underneath one of the wheels which supports the rotary platter, it results in a rigid assembly with faster response to weight changes. Fastest response is an important criterion when assessing suitability for use in some retail situations.

The use of a rigid frame joining the load cell loading points and supporting the wheels prevents side loading or moment forces from reaching the load cells, which could reduce accuracy or possibly damage the load cells if sufficiently high in value.

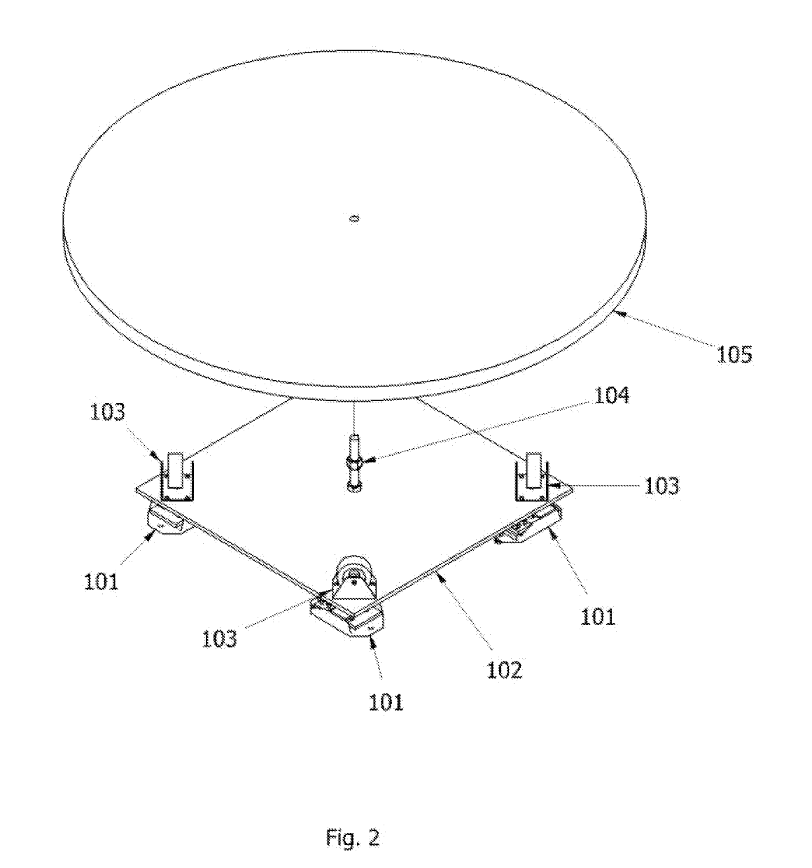

FIG. 2 shows an exploded view of the scale assembly. Load cells 101, via resilient mounts (not shown in FIG. 2), support the frame 102 on which wheels 103 and a central shaft 104 are mounted. The rotary platter 105 sits on the wheels 103 and is centered by the shaft 104. The rotary platter 105 is free to rotate along the central shaft 104.

In a preferred embodiment, the rotary carousel scale utilizes typically four load cells of either planar-beam or single-point type, fitted with the frame and the wheels to support the rotary platter. A planar beam load cell type, when compared with the average single-point load cell, has a more linear response or, putting it another way, the error over the range from zero to full scale is lower.

The planar beam load cells used in this application are calibrated to be equal in output, with a small margin of error. They are either connected in parallel, which has the effect of giving the numerical average of the outputs of all the load cells within a very tight margin, or connected separately to different inputs on a signal conditioner or transmitter which sums the separate inputs, allowing them to be combined into a value that is translated into lb or kg for use. They work in combination to give an equal reading when a weight is placed anywhere on the rotary platter. Each load cell used is preferably adjusted during factory calibration to give the same output, measured in millivolts, when the same load is applied. The allowable error is preferably +/−0.1% of reading.

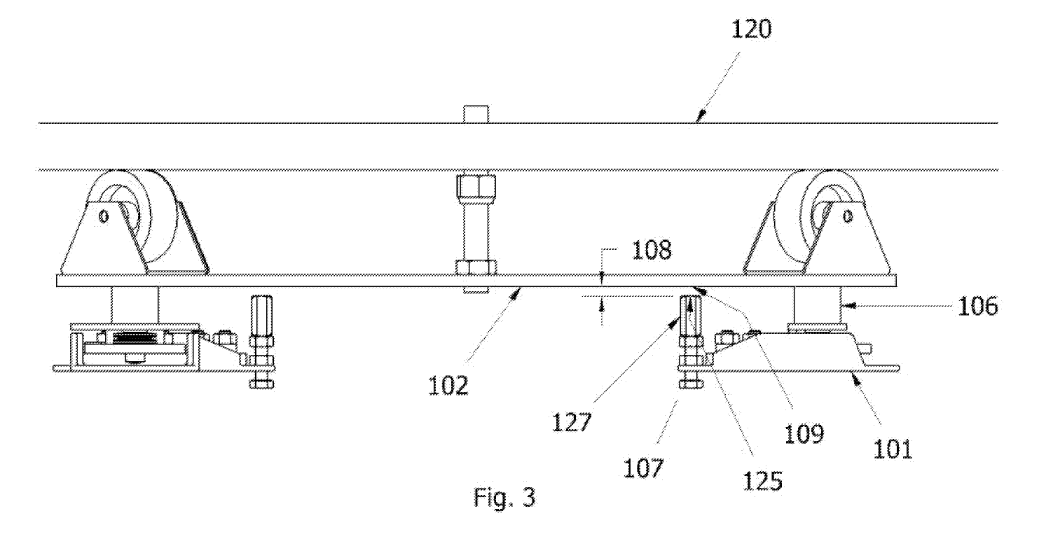

FIG. 3 shows the components of the vertical overload protection device 107 when in the non-overloaded state. As load increases, the gap 108 closes until the bottom surface 109 of the frame 102 contacts the overload stop portion 125. At this point, no further load is transmitted to the load cell, protecting it from damage. In a preferred embodiment, the overload protection device 107 is a rigid shaft made from metal having a substantially upper planar surface adapted to stop further downward movement of the frame 102.

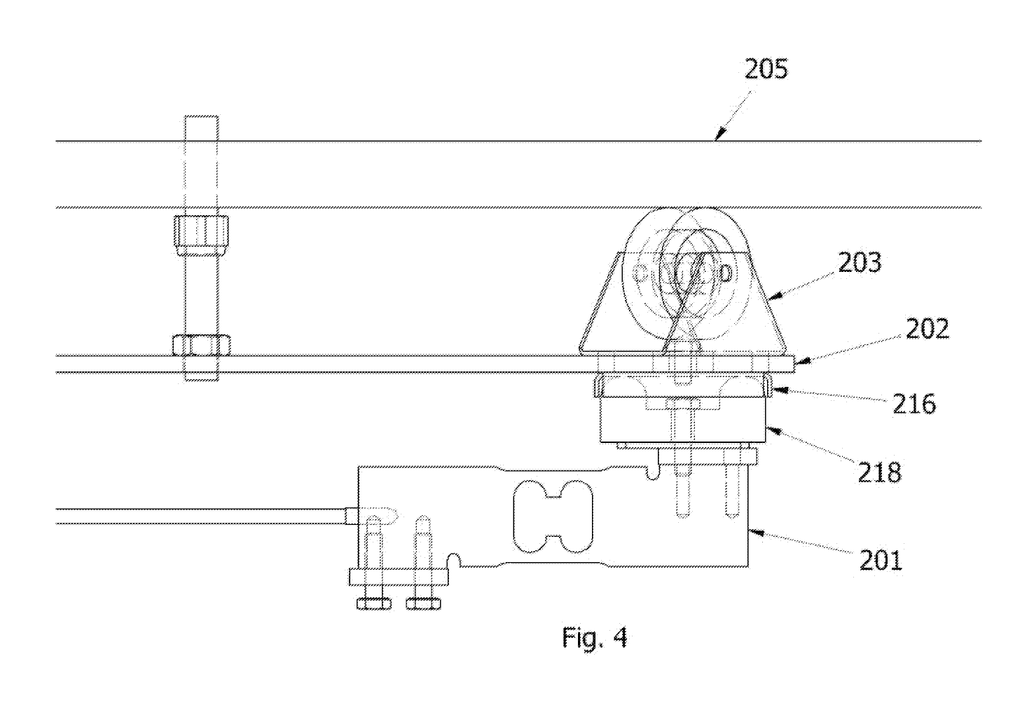

FIG. 4 shows an alternative mounting method in which the frame 202 supporting wheels 203 and rotary platter 205 are loosely mounted on several load cells 201 whist being restrained horizontally by the use of metal or plastic brackets or cups 216. This illustration shows a different type of load cell, which is equally suitable for the application, with a “rubber-bumper” 218 style of resilient mount, which is also equally suitable for the application. The loose mount allows the rotary platter 205 and the frame 202 to be removed as a single assembly to facilitate cleaning and service of the weighing components below.

The frame can be attached through rubber ‘vibration mounts’ which have either threaded studs or female threaded inserts at their top and bottom. The rubber allows enough lateral movement to ensure accuracy but only a small amount of vertical movement, preserving rigidity and maximizing speed of response. Equally well, rubber ‘bumpers’ (similar to the rubber feet found on many appliances) can be used provided that some form of horizontal location is provided. FIG. 4 shows a simple metal square with downturned edges.

Typical ‘vibration mounts’ made from rubber are available from hardware supply houses such a Spae-Naur. The rubber is vulcanized onto an upper and lower metal plate onto/into which the threaded restraint is mounted.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) A rotary carousel scale comprising:
a) a rotary platter mounted on a shaft, said shaft being located at the center of said rotary platter, said rotary platter being free to rotate along said shaft;
b) at least three load cells comprising loading points;
c) a plurality of resilient mounts, said resilient mounts being connected to said loading points of said load cells;
d) a frame disposed on said resilient mounts;
e) a plurality of wheels, said wheels being disposed on said frame, said rotary platter being disposed on said wheels, and said rotary platter rotating on said wheels.

2) The rotary carousel scale of claim 1, wherein said frame is rigidly attached to said resilient mounts.

3) The rotary carousel scale of claim 1, further comprising an overload protection device comprising a body and a stop portion, said stop portion being adapted to stop a downward movement of said frame.

4) The rotary carousel scale of claim 1, wherein each of said load cells is installed underneath one of said wheels.
